(19) United States
(12) Patent Application Publication
(10) Pub. No.: US 2007/0178340 A1
(43) Pub. Date: Aug. 2, 2007

(54) Fuel cell power generator with micro turbine

(75) Inventor: Steven J. Eickhoff, Plymouth, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International Inc.

(21) Appl. No.: 11/343,657

(22) Filed: Jan. 31, 2006

(51) Int. Cl. H01M 8/06; H01M 8/04

(52) U.S. Cl. 429/19; 429/22; 429/25; 429/13; 60/735

(57) ABSTRACT

A power generator has a high pressure hydrogen generator controllably coupled to a micro turbine generator and a fuel cell. The micro turbine generator may utilize the high pressure hydrogen to provide transient power levels while the fuel cell provides static power levels. In one embodiment, an electrically controlled valve is used to control the flow of hydrogen from the hydrogen generator to the micro turbine generator.

### BACKGROUND

In some fuel cell based power generators, hydrogen is extracted from a fuel in the presence of water and then is introduced into a fuel cell to produce electricity. Power generators based on hydrogen generators and proton exchange membrane (PEM) fuel cells typically have difficulty in providing transient power needed in portable devices, such as wireless transceivers and actuators. In other words, such portable devices may require relative high power levels over short periods of time, and low power levels over other periods of time. Such power generators may have difficulty quickly generating the high power levels.

### SUMMARY

A power generator has a high pressure hydrogen generator controllably coupled to a micro turbine generator and a fuel cell. The micro turbine generator may utilize the high pressure hydrogen to provide transient power levels while the fuel cell provides static power levels. In one embodiment, an electrically controlled valve is used to control the flow of hydrogen from the hydrogen generator to the micro turbine generator.

### BRIEF DESCRIPTION OF THE DRAWINGS

FIG. 1 is a block diagram of a power generator incorporating a micro turbine generator according to an example embodiment.

FIG. 2 is a block diagram of an alternative power generator incorporating a micro turbine generator according to an example embodiment.

FIG. 3 is a detailed block diagram of a power generator incorporating a micro turbine generator according to an example embodiment.

FIG. 4 is a graph diagram depicting power demands of a load and power supplied by a power generator according to an example embodiment.

FIG. 5 is a detailed block diagram of an alternative power generator incorporating a micro turbine generator according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

A fuel cell based electrical power generator having a micro turbine generator is described in this application. Hydrogen is controllably provided from a high pressure hydrogen generator to the micro turbine to produce desired bursts of high power. The power generator may provide improved energy density, specific energy, pulse power capability and efficiency of power generators. Pulse power capability may be referred to as transient power, which steady state levels of power may be referred to as static power levels.

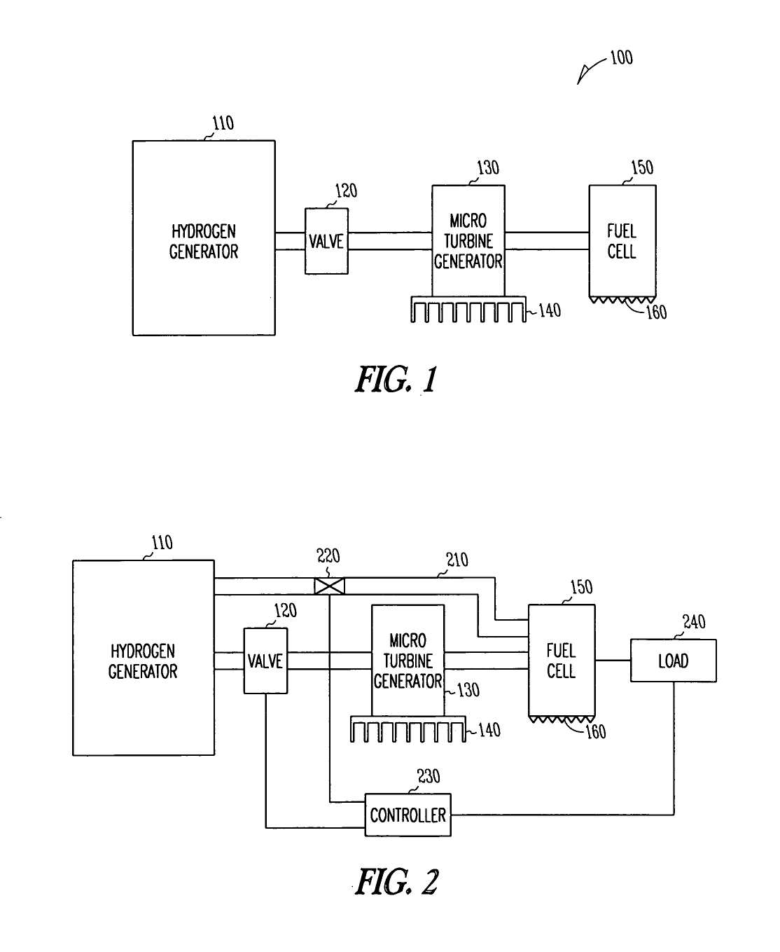

FIG. 1 illustrates a block diagram of a power generator 100 having increased peak power and transient power capabilities. A high pressure hydrogen generator 110 may be a chemical based hydrogen generator that generates hydrogen in the presence of water. High pressure, in various embodiments, may be thought of as generating hydrogen at pressures of between approximately 10 to 1000 PSI, or approximately 100 PSI in one embodiment.

The hydrogen generator 110 is coupled to a valve 120 that may be controlled, such as by electronics, to provide hydrogen at a desired flow rate to a micro turbine generator 130. The desired flow rate may be controlled responsive to demand for power from a device receiving power from the power generator 110, such as a wireless sensor with a transmitter that may need extra power for periodic transmissions. In further embodiments, the valve 120 may be down line from the micro turbine generator 130. In one embodiment, the micro turbine generator 130 includes a heat exchanger 140 for cooling the micro turbine generator 130.

Hydrogen passing through the micro turbine generator 130 may also be provided to a fuel cell 150. In one embodiment, the fuel cell comprises a proton exchange membrane that converts the hydrogen, along with oxygen from ambient into electricity. In one embodiment, the pressure in the fuel cell 150 is controlled by at least one of various means. An expandable wall 160 may be used to increase the volume of the fuel cell and hence lower the pressure of the hydrogen. The expandable wall may be formed of metal in an accordion shape to allow expansion. Other flexible type membranes may also be used. The expandable wall or membranes may function to keep pressure fairly constant, and prevent the loss of hydrogen. A pressure relief valve may also be used.

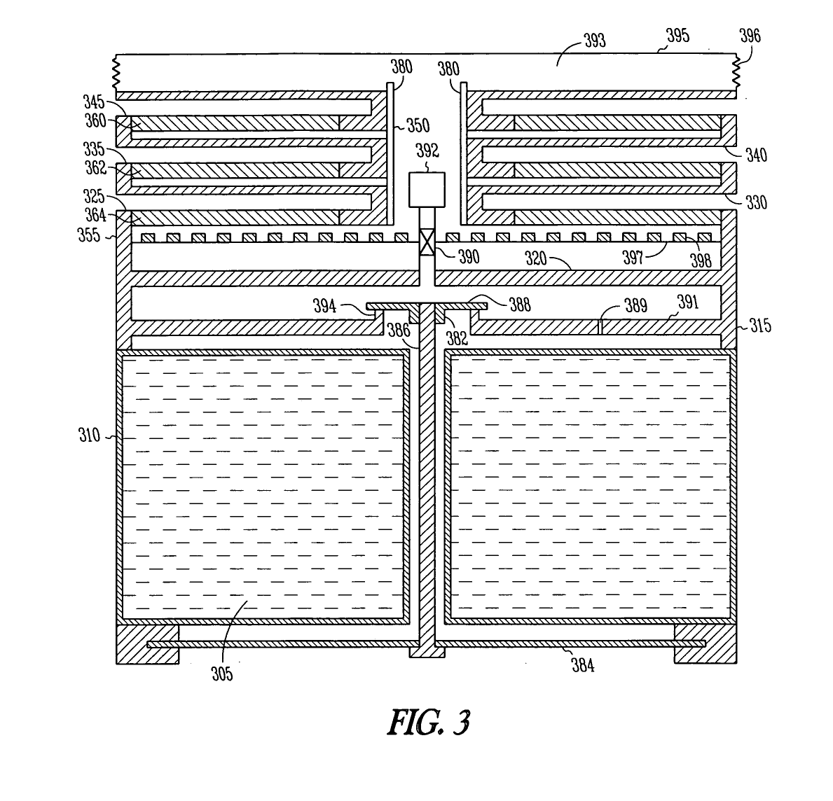

FIG. 2 is a block diagram of an alternative power generator having numbering consistent with FIG. 1. In addition, FIG. 2 shows a secondary path 210 extending from hydrogen generator 110 to the fuel cell or fuel cell stack 150. The secondary path 210 may include a throttling valve 220 that may operate to control the flow of hydrogen to the fuel cell stack for producing normal power levels. Normal power levels, or static power levels, are power levels that are fairly steady, and within the power generating capabilities of the fuel cell 150. During periods of increasing demand, referred to as transient power demand, hydrogen may be flowed through the micro turbine generator. Such transient demand may result in generation of pulses of power, such as for devices that have transient power demands.

Controller electronics 230 may be coupled to the valve 120 to control the amount of hydrogen flowed through the micro turbine generator 130. The electronics may be coupled to load 240 such as a device or devices using power generated from the power generator 100. The devices may provide indications that an increase in power will be needed, referred to as rate predictive, or the electronics may simply measure increased power demand from the device or devices, referred to as rate responsive. In further embodiments, electronics may learn the power requirements of load 240 coupled to the power generator 100, and control the valve appropriately to produce transient power as needed. In a further embodiment, controller 230 is coupled to throttling valve 220 to control flow of hydrogen to the fuel cell 150.

FIG. 3 is a cross sectional view of a pressure regulated power generator 300. Power generator 300 contains a hydrogen producing fuel 305 in a container 310. A support structure 315 is coupled to the container and contains a plurality of plates 320, 325, 330, 335, 340 and 345 in a stacked relationship in one embodiment. The plates are coupled together via an inside column 850 and via an outside ring structure 355. This coupling provides an accordion like cross section, and allows ambient air to flow to cathode sides of multiple fuel cells in multiple layers indicated at 360, 362 and 364. The inside column 350 allows hydrogen generated from fuel 305 to flow to anode sides of the multiple fuel cells in multiple layers. Electrodes 380 are also shown coupling the multiple layers together to provide desired power levels.

Support structure 315 is electrically isolated from the fuel cells in one embodiment. It may be constructed of a plastic such as PET, stainless steel, or other materials that provide sufficient support.

In one embodiment, the outside ring structure 355 may have holes or openings corresponding to passages or channels between plates or support structure 315 to allow passage of ambient air to the cathodes. It may also be completely open as indicated, or simply have pillars or other supporting structures to provide mechanical stability as desired. The inside column 350 may be similarly constructed to allow access of the anodes to hydrogen.

Plates 325, 335 and 345 provide support structures for supporting the fuel cells. As indicated above, each fuel cell has proton exchange membrane that converts hydrogen and oxygen into electricity and water in one embodiment. A cathode and an electrode are disposed about the proton exchange membrane to conduct the generated electricity. The plates also ensure that each side of the fuel cell is exposed to the proper medium, such as ambient air for cathode sides and hydrogen for anode sides of the fuel cells. Plates 320, 330 and 335, which alternate with the support plates, serve as a barrier to ambient for the anodes, and also provide a path or channel from ambient to the cathodes.

In one embodiment, a pressure regulated valve 382 is disposed between the hydrogen producing fuel and the fuel cells. The valve consists of a pressure responsive flexible diaphragm 384 disposed on a first side of the hydrogen producing fuel, and a piston or stem 386 connecting a valve disc or plate 388 for seating on a plate 391 of the support structure. Plate 391 may have an annular seat ring 394 for making a sealing contact with the plate valve 388.

In the embodiment shown, the diaphragm is opposite the fuel cells from the fuel. In further embodiments, the diaphragm may be positioned on the same side, or in various different places on the power generator as desired. The diaphragm operates in a manner similar to the above described embodiments. The fuel 805 may also be constructed in a manner similar to the above described embodiments.

In one embodiment, the diaphragm 384 is designed with a spring constant sufficient to create a high pressure of hydrogen within the hydrogen generator 310. Such pressures in one embodiment range from 10 PSI to over 100 PSI. In one embodiment, the pressure is approximately 100 PSI. Hydrogen pressure on both sides of the valve plate 388 is the same (it always leaks slightly). A water vapor partial pressure difference exists across the valve plate, and operates to control the amount of hydrogen produced. In one embodiment, a capillary tube 389 (a very small diameter tube) connects both sides of the valve to maintain constant hydrogen pressure on both sides of the valve plate. While shown through the plate 391, it may be located anywhere where it can function to equalize the hydrogen pressure yet not allow significant amounts of water vapor to pass. Hydrogen is provided via a path leading to a controlled valve 390 and to a micro turbine generator 392 for generating electricity, such as for transient demands. Hydrogen passing through the generator is released to the fuel cell electrodes for generating electricity.

When valve 392 releases more hydrogen than can immediately be consumed by the proton exchange membranes, a chamber 393 that is bounded by a membrane 395 coupled to an expandable wall 396. In further embodiments, membrane 395 may be very flexible and formed of a stretchable material, such as rubber, acting like a balloon to hold excess hydrogen until it can be consumed by the proton exchange membranes.

A further membrane 397 is disposed between the diaphragm 384 and the fuel cells. It provides a water vapor permeable and hydrogen impermeable material that allows water, such as water vapor produced by the fuel cells, to return to the hydrogen generator and produce more hydrogen. In one embodiment, the membrane 397 is formed of a Nafion® layer. Due to the high pressure difference between the fuel cells and the hydrogen generator, an additional reinforcement layer 398 may be used to support the membrane 397. The reinforcement layer 398 may be formed of metal, plastic, or other supportive material and be porous such that water vapor may move through the membrane 397.

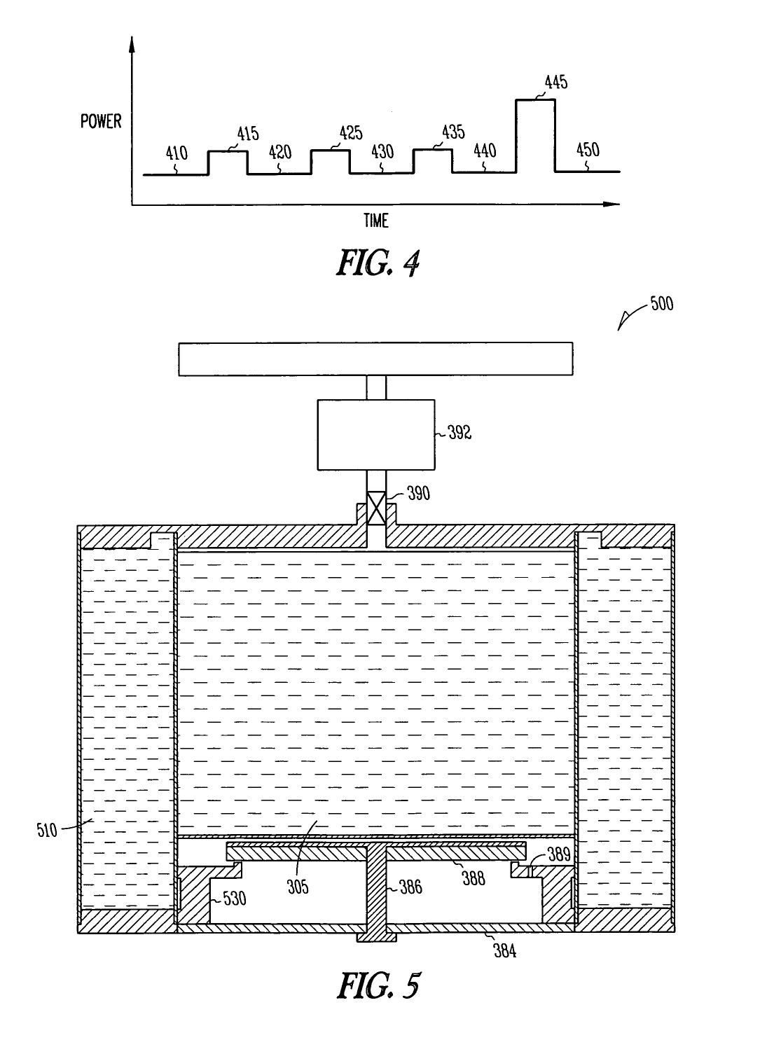

FIG. 4 shows power requirements for a load 350. A static load is illustrated at 410, which is a relatively lower power requirement. At 415, a spike in power requirement is illustrated. The fuel cells may be designed to provide power in a steady state, or slowly changing power level at about the level illustrated at 410, it may not be able to ramp up for the transient demand created at 415. To meet this demand in a short time frame, the controller 230 may open the controlled valve 120 a desired amount for a period of time sufficient to generate an additional amount of power such that the power generator provide sufficient additional power to meet the demand at 415.

In one embodiment, the demand may be somewhat periodic as illustrated by continued regular spikes in power demand in FIG. 4. At 420, the demand is low, at 425, the demand is again high. At 430 the demand is low and then high again at 435. The demand is low again at 440. These spikes in demand may be predicted by the electronics, and the controlled valve 120 opened in time to meet the demand without a significant drop in voltage or current. Such regular spikes may occur in loads such as wireless transmitters, which conserve power by transmitting only at intervals, which may be regular. Such loads may also inform the controller 230 of a need for more power prior to the power being needed, allowing the controller to ramp up power production by increasing the hydrogen flow through the micro turbine generator 130.

At 445, the demand greatly increases. The controller may control the control valve 120 to allow an even greater flow of hydrogen to the micro turbine generator 130 to meet the demand. The load may inform the controller in various embodiments of an amount of power that will be required. As seen at 450, the demand returns to a normal or static level. In one embodiment, the expandable portion of the fuel cell may be sufficient to hold hydrogen passed through the micro turbine generator to meet the demand. In further embodiments, a relief valve may be provided to prevent the membrane from rupturing.

FIG. 5 is a detailed block diagram of an alternative power generator 500 incorporating a micro turbine generator 392 according to an example embodiment. The generator is similar to power generator 300 and has like parts similarly numbered. Power generator 500 may be formed with a water chamber 510, that provides water to the hydrogen fuel 305. In this embodiment, the valve disc 388 and flexible diaphragm 384 are located on one side of the fuel 305, with the microturbine generator 392, controlled valve 390 and fuel cells 520 located opposite the fuel 305. A seat 530 is provided for the valve disc 388 such that when hydrogen pressure decreases, the valve opens, providing water vapor to the hydrogen fuel 305 from the water chamber 510, causing an increase in hydrogen production and a commensurate pressure increase. Thus, when the controlled valve 390 is opened, the hydrogen pressure adjusts automatically to compensate for the drop in pressure. Water generated at the fuel cells may be vented to ambient, or otherwise disposed of. A capillary 389 may also be provided in seat 530 or elsewhere to equalize hydrogen pressure as in FIG. 3.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A power generator comprising:
a hydrogen generator;
a micro turbine generator coupled to the hydrogen generator that receives a flow of hydrogen from the hydrogen generator and generates electricity from such flow; and
a fuel cell coupled to the hydrogen generator.

2. The power generator of claim 1 wherein the hydrogen generator comprises a high pressure chemical based hydrogen generator.

3. The power generator of claim 2 wherein the hydrogen generator has a diaphragm controlled valve for regulating water vapor within the hydrogen generator.

4. The power generator of claim 3 wherein the diaphragm controlled valve includes a capillary tube that maintains substantially constant hydrogen pressure across the valve.

5. The power generator of claim 1 and further comprising a controllable valve that controls the flow of hydrogen to the micro turbine generator.

6. The power generator of claim 5 wherein the controllable valve is coupled between the hydrogen generator and the micro turbine generator.

7. The power generator of claim 5 wherein the controllable valve is electronically controllable.

8. The power generator of claim 7 wherein the controllable valve increases the flow of hydrogen to the micro turbine generator in advance of increased power demand by a load.

9. The power generator of claim 1 and further comprising a heat exchanger coupled to the micro turbine generator.

10. The power generator of claim 1 and further comprising a throttled secondary hydrogen path between the hydrogen generator and the fuel cell.

11. The power generator of claim 1 wherein the fuel cell comprises means for controlling fluid pressure in the fuel cell.

12. The power generator of claim 11 wherein the means for controlling fluid pressure in the fuel cell comprises an expandable wall or a relief valve.

13. The power generator of claim 1 and further comprising a water vapor permeable and hydrogen impermeable membrane disposed between the hydrogen generator and the fuel cell.

14. A power generator comprising:
a hydrogen generator;
means for providing water to the hydrogen generator;
a micro turbine generator coupled to the hydrogen generator that receives a flow of hydrogen from the hydrogen generator and generates electricity from such flow;
a controllable valve that controls the flow of hydrogen to the micro turbine generator;
a fuel cell coupled to the hydrogen generator; and
means for controlling fluid pressure within the fuel cell.

15. The power generator of claim 14 wherein the hydrogen generator comprises a high pressure chemical based hydrogen generator.

16. The power generator of claim 15 wherein the hydrogen generator has a diaphragm controlled valve for regulating hydrogen pressure within the hydrogen generator.

17. The power generator of claim 14 wherein the controllable valve is coupled between the hydrogen generator and the micro turbine generator.

18. The power generator of claim 14 and further comprising a heat exchanger coupled to the micro turbine generator.

19. The power generator of claim 14 and further comprising a throttled secondary hydrogen path between the hydrogen generator and the fuel cell.

20. The power generator of claim 14 wherein the means for controlling fluid pressure in the fuel cell comprises an expandable wall or a relief valve.

21. A method of increasing peak power from a generator, the method comprising:
providing high pressure hydrogen;
providing the hydrogen to a proton exchange membrane based fuel cell to generate electrical power; and
controlling a flow of hydrogen through a micro turbine generator to generate additional electrical power.

22. The method of claim 21 wherein the hydrogen provided to the fuel cell is first flowed through the micro turbine, and further comprising:
controlling pressure within the fuel cell.

23. The method of claim 21 wherein the flow of hydrogen through the micro turbine generator is performed by an electronically controlled valve responsive to power needs of a device.
